(19) United States
(12) Patent Application Publication
(10) Pub. No.: US 2021/0122462 A1
(43) Pub. Date: Apr. 29, 2021

(54) RELOCATABLE MAIN LANDING GEAR

(71) Applicant: Robert G. Watkins, East Fallowfield, PA (US)

(72) Inventor: Robert G. Watkins, East Fallowfield, PA (US)

(21) Appl. No.: 16/665,683

(22) Filed: Oct. 28, 2019

Related U.S. Application Data
(63) Continuation-in-part of application No. 16/664,214, filed on Oct. 25, 2019.

(51) Int. Cl. B64C 25/22; B64C 25/52; B64C 25/36

(52) U.S. Cl. CPC B64C 25/22; B64C 25/36; B64C 25/52

(57) ABSTRACT

An aircraft having a fuselage extending in a longitudinal direction from a nose to a tail, and a main wheel assembly having a first main wheel spaced in a transverse direction from a second main wheel, the transverse direction being perpendicular to the longitudinal direction. One or more pivots connect the main wheel assembly to the fuselage. The one or more pivots have a rotation axis extending in the transverse direction such that the main wheel assembly is pivotable relative to the fuselage between a first fixed position with the first main wheel and the second main wheel in a first longitudinal position behind a center of gravity of the aircraft, and a second fixed position with the first main wheel and the second main wheel in a second longitudinal position behind the center of gravity of the aircraft. One or more extendable struts are operatively connected between the main wheel assembly and fuselage, and operable to move the main wheel assembly between the first fixed position and the second fixed position.

This is a continuation-in-part of U.S. application Ser. No. 16/664,214, filed Oct. 25, 2019, the contents of which are incorporated by reference in their entirety.

### TECHNICAL FIELD

This disclosure relates to the field of aircraft landing gear.

### BACKGROUND

Typical aircraft include landing gear having either a nose wheel or a tail wheel. Tailwheel aircraft have two (left and right) main landing gear assemblies that are spaced apart in the lateral direction (e.g. one on each side of the fuselage or one on each main wing), with the tailwheel (or other support, such as a skid) located behind the main landing gear. This configuration is commonly referred to as a “conventional” landing gear arrangement. In contrast, nose wheel aircraft have a nose wheel located in front of the two main landing gear assemblies. This is commonly called a “tricycle” or “tri-gear” landing gear arrangement.

Each type of landing gear arrangement has advantages and disadvantages.

Conventional gear typically perform better on rough terrain, where the distribution of the main landing gear helps stabilize the aircraft on rough terrain or soft surfaces. Conventional gear also typically hold the main wings at a greater angle of attack relative to the ground, thus making them more suitable for short takeoff and landing (“STOL”) operations. However, conventional gear are less stable during landings in crosswinds, during which high lateral loads can cause the aircraft to enter a “ground loop” in which the aircraft pivots horizontally around the main gear, risking contact between the wing and the ground and other damage. Aircraft with conventional gear are also more likely to nose over during sudden heavy braking, and can potentially flip entirely over.

Tricycle gear have three significant advantages over conventional gear. First, the nose wheel provides longitudinal stability during landing, thus virtually eliminating the possibility of entering a ground loop. Second, the nose wheel reduces the likelihood of nosing over during braking. Third, greater breaking force is generally available. Despite these advantages, tricycle gear are much less useful on rough terrain and softer surfaces, in which the single nose gear is more likely to dig into the surface and potentially collapse or lead to a nose over.

As a consequence of these advantages and disadvantages, conventional gear are typically favored for off-runway use, and tricycle gear are typically favored for on-runway use.

Historically, landing gear on aircraft are configured either as conventional gear or as tricycle gear, but not both. The reason for this is that the location of the main wheels relative to the center of gravity must be selected to establish proper stability for the selected configuration. Thus, main landing gear are not positioned appropriately to allow the aircraft to alternate between tailwheel operation and tricycle operation. Despite this, a small number of aircraft are known to include both forward and rearward supports. For example, the BAC “Concord” supersonic transport (introduced in 1976) was configured with tricycle landing gear and operated with the nose gear on the ground during normal takeoff and landing, but included a small retractable tail wheel as protection against ground strikes between its elongated tail cone and the ground. As another example, the Royal Aircraft Factory F.E.2 fighter (introduced in 1915) was configured with conventional landing gear and normally operated during takeoff and landing with the back of the aircraft supported by a tailskid, but included a small forward wheel to prevent nose overs when landing in soft terrain (the wheel was often removed by aircrews). Finally, the Ilyushin IL-62 transport (introduced in 1963) was configured with a tricycle gear and operated during takeoff and landing with the aircraft supported on the nose gear, but included a retractable “tail prop” to prevent the aircraft from tipping backwards when unloaded on the ground. It has also been suggested to provide a conventional gear aircraft with a movable main landing gear to allow the main wheels to move forward to help prevent nose-overs, as seen in U.S. Pat. No. 1,493,022, but such aircraft is not known to have a forward landing gear and thus the main gear would have been configured to operate as a conventional gear aircraft under all circumstances. Furthermore, such a configuration would increase the effect of cross-wind side loads on the aircraft, making it more likely to experience ground loops.

This description of the background is provided to assist with an understanding of the following explanations of exemplary embodiments, and is not an admission that any or all of this background information is necessarily prior art.

### SUMMARY

In a first aspect, there is provided an aircraft having: a fuselage extending in a longitudinal direction from a nose to a tail; a main wheel assembly having a first main wheel spaced in a transverse direction from a second main wheel, the transverse direction being perpendicular to the longitudinal direction; and one or more pivots connecting the main wheel assembly to the fuselage. The one or more pivots have a rotation axis extending in the transverse direction such that the main wheel assembly is pivotable relative to the fuselage between a first fixed position with the first main wheel and the second main wheel in a first longitudinal position behind a center of gravity of the aircraft, and a second fixed position with the first main wheel and the second main wheel in a second longitudinal position behind the center of gravity of the aircraft. One or more extendable struts are operatively connected between the main wheel assembly and fuselage, and operable to move the main wheel assembly between the first fixed position and the second fixed position.

In some examples, the aircraft may further include a nose wheel located adjacent the nose and a tail support located adjacent the tail, with the main wheel assembly between the nose wheel and the tail support with respect to the longitudinal direction. The tail support may be, for example, a wheel or a skid. At least one of the nose wheel and the tail support may be removable.

In some examples, the first main wheel and the second main wheel may be separately movable between the first longitudinal position and the second longitudinal position.

In some examples, the one or more extendable struts may include one or more screw jacks.

In some examples, the one or more extendable struts may include one or more hydraulic piston and cylinder assemblies.

In some examples, the one or more extendable struts may include one or more pneumatic piston and cylinder assemblies.

### BRIEF DESCRIPTION OF THE DRAWINGS

Exemplary embodiments will now be described, strictly by way of example, with reference to the accompanying drawings, in which:

FIG. 1 shows a first exemplary embodiment of an aircraft having the main landing gear in a first landing gear configuration.

FIG. 2 shows the embodiment of FIG. 1 with the main landing gear in a second landing gear configuration.

FIG. 3 is a schematic plan view of a landing gear assembly such as described in relation to FIG. 1, shown in a first configuration.

FIG. 4 is a schematic plan view of the landing gear assembly of FIG. 3, shown in a second configuration.

FIG. 5 is a front cross-section view of the landing gear assembly of FIG. 3, shown along line V-V.

FIG. 6 is a side cross-section view of the landing gear assembly of FIG. 3, shown along line VI-VI.

FIG. 7 shows a second exemplary embodiment of an aircraft having the main landing gear in a first landing gear configuration.

FIG. 8 shows the embodiment of FIG. 7 with the main landing gear in a second landing gear configuration.

FIG. 9 shows a third exemplary embodiment of an aircraft having the main landing gear in a first landing gear configuration.

FIG. 10 shows the embodiment of FIG. 9 with the main landing gear in a second landing gear configuration.

FIG. 11 shows a fourth exemplary embodiment of an aircraft having the main landing gear in a first landing gear configuration.

FIG. 12 shows the embodiment of FIG. 11 with the main landing gear in a second landing gear configuration.

FIG. 13 shows a fourth exemplary embodiment of an aircraft having the main landing gear in a first landing gear configuration.

FIG. 14 shows the embodiment of FIG. 13 with the main landing gear in a second landing gear configuration.

FIG. 15 is a bottom schematic view of a fifth exemplary embodiment of an aircraft having repositionable main landing gear.

FIG. 16 shows a sixth exemplary embodiment of an aircraft having the main landing gear in a first landing gear configuration.

FIG. 17 shows the embodiment of FIG. 16 with the main landing gear in a second landing gear configuration.

### DESCRIPTION OF EXEMPLARY EMBODIMENTS

Embodiments described herein provide an aircraft having its landing configured to operate in a hybrid of conventional and tricycle landing gear configurations. Embodiments also may provide main landing gear that are movable relative to the longitudinal axis of the aircraft between a first (hybrid) landing gear configuration and a second (tricycle) landing gear configuration. Such embodiments may be provided as an aircraft assembly, as a complete aircraft, as a retrofit assembly, or in any other suitable form.

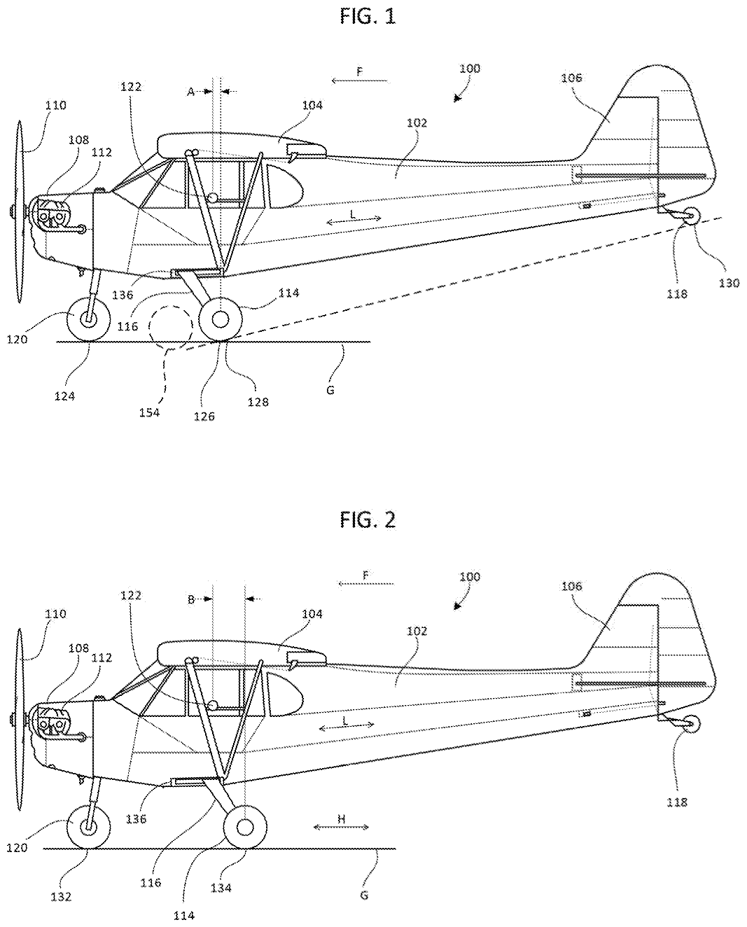

A first exemplary embodiment is illustrated in FIGS. 1 through 6. Beginning with FIGS. 1 and 2, an exemplary aircraft 100 comprises a fuselage 102, main wings 104, a tail 106, and a nose 108. The aircraft 100 extends in a longitudinal direction L between the nose 108 and the tail 106. The nose 108 may include a propeller 110 and associated engine 112, but the propeller 110 (or propellers) and engine 112 may instead be mounted on the wings 104 or elsewhere. Also, other thrust-generating equipment may be used in other embodiments, such as wing-mounted or fuselage-mounted jet or turbine engines or the like. The tail 106 includes control and stabilizing surfaces, such as horizontal and vertical stabilizers, a rudder, elevators, and so on, as known in the art. The single tail 106 also may be replaced by multiple tails.

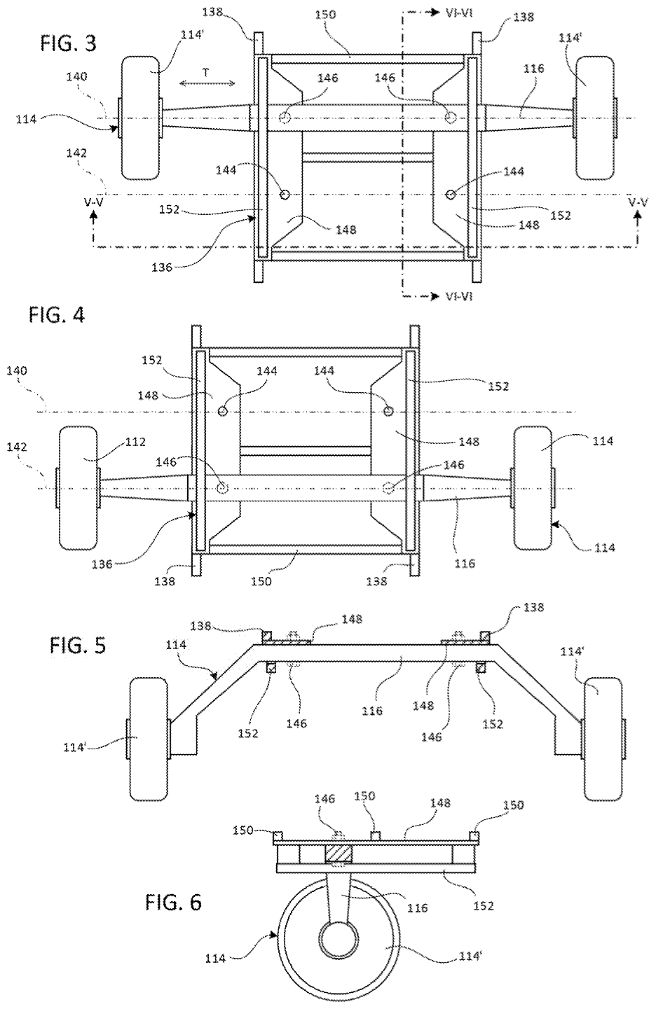

As best shown in FIGS. 3-5, the aircraft 100 includes a main wheel assembly 114 having two or more wheels 114′ arranged along a transverse axis T that is perpendicular to the fore-aft flight direction F, with one or more wheels 114′ on each side of the aircraft's longitudinal centerline. The wheels 114′ are connected by a cross-member 116. The main wheel assembly 114 also may include brakes, as known in the art. The wheels 114′ are generally coaxial with each other (i.e., their respective axles lie along the same line), and some deviation from a perfect coaxial arrangement may be present particularly if the cross-member 116 is arranged to flex to provide shock absorbing.

The illustrated cross-member 116 is a beam axle that is configured to flex to allow the wheels 114′ to move to some degree to provide a rudimentary suspension. The cross-member 116 alternatively may include articulated suspension members, such as a separate spring-biased trailing arm supporting each wheel 114′, telescoping shock absorbers, and so on. The cross-member 116 also may be replaced by any other suitable separate suspension member or linkage for each wheel 114′.

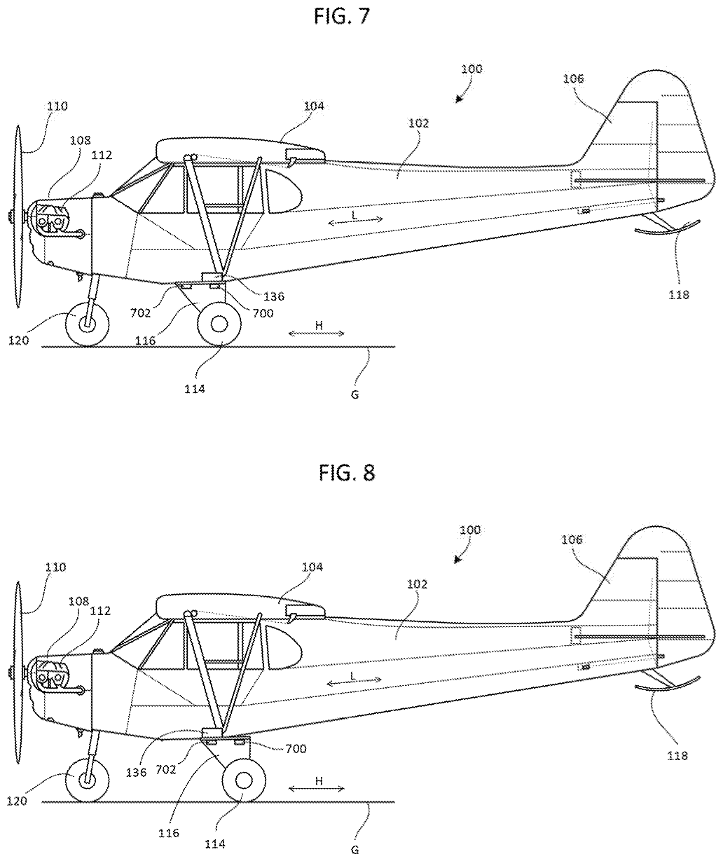

The aircraft 100 also includes a tail support 118 located at or near the tail 106, and a nose wheel 120 located at or near the nose 108. The tail support 118 is located aft of the main wheel assembly 114 with respect to the longitudinal direction L. The tail support 118 may include one or more wheels, skids or the like (a wheel is shown in FIGS. 1 and 2, and a skid is shown in FIGS. 7-8). The nose wheel 120 may include an assembly of one or more wheels, and may include a steering mechanism, brakes, a shock absorbing system such as a telescoping strut, and so on. One or both of the tail support 118 and nose wheel 120 may be removable from the aircraft 100, or may be retractable into the aircraft 100 when not in use. The aircraft 100 also may be provided without one or both of the tail support 118 and nose wheel 120, depending on customer preferences.

As shown in FIGS. 1 and 2, the main wheel assembly 114 optionally may be movable between a first configuration as shown in FIG. 1, and a second configuration as shown in FIG. 2. In the first configuration, the main wheel assembly 114 is at a first longitudinal position relative to the aircraft's center of gravity 122 (dimension A), and in the second configuration the main wheel assembly 114 is at a second longitudinal position (dimension B) relative to the aircraft's center of gravity 122. The second longitudinal position is behind the first longitudinal position. In each position, the main wheel assembly 114 is fixed for landing (i.e., fully-deployed and configured to support the aircraft 100 during takeoff and landing, but movable upon any suspension provided for the wheels 114′).

When the main wheel assembly 114 is in the first configuration, the aircraft 100 is in a hybrid conventional/tricycle landing gear configuration (hereinafter a “hybrid” configuration). In the hybrid configuration, the aircraft 100 may be operated as a tricycle gear configuration, in which it is supported during takeoff and landing by the nose wheel 120 in the front and the main wheel assembly 114 in the rear. To this end, the positions of the main wheel assembly 114 and the center of gravity 122 are selected such that the center of gravity 122 is between the main wheel assembly 114 and the nose wheel 120 when the aircraft 100 is on the ground with the nose wheel 120 in contact with the ground. More specifically, the nose wheel 120 defines a front point of contact 124 with the ground G, and the main wheel assembly 114 defines a rear point of contact 126 with the ground G, and the center or gravity 122 is located between the front point of contact 124 and the rear point of contact 126 with respect to a horizontal direction H extending from the front point of contact 124 to the rear point of contact 126 (e.g., in front of the rear point of contact 126 by a distance A as shown in FIG. 1).

For purposes of this explanation, the “point of contact” refers to the effective point of contact at the lateral center of the aircraft 100 (e.g., for the main wheel assembly 114 the “point of contact” is a location where a straight line connecting the points of contact for each individual wheel 114′ intersects the centerline of the aircraft 100). In most cases, the aircraft main landing gear will be symmetrical, and thus the point of contact will be understood to simply be the location at which the wheels 114′ of the main wheel assembly 114 contact the ground G.

It will also be appreciated that the points of contact 124, 126 and center of gravity 122 of the aircraft 100 can move depending on the underlying terrain (uneven ground, local bumps and holes, etc.) and the aircraft load (e.g., fuel, passengers, equipment, luggage, and the like). Thus, except as otherwise indicated, references to the points of contact are to the points of contact on level ground, and references to the center of gravity are to the aircraft's aft center of gravity (i.e., the rearmost limit of the center of gravity during flight, as specified by the aircraft manufacturer) while the aircraft 100 is parked on level ground.

In the first (hybrid) configuration, the main wheel assembly 114 optionally may be positioned relative to the center of gravity 122 such that the aircraft 100 can statically rest on the ground G on either the tail support 118, or on the nose wheel 120. For example, when the aircraft 100 is tilted rearward with the tail support on the ground G (as shown by the broken line) the center of gravity 122 may be positioned between a front point of contact 128 between the main wheel assembly 114 and the ground G, and a rear point of contact 130 between the tail support 118 and the ground G. Thus, the aircraft 100 is stable on the ground in either of two positions: nose down or tail down.

More preferably, however, the main wheel assembly 114 is positioned in the hybrid configuration such that the aircraft 100 will statically rest only on the nose wheel 120 (in combination with the main wheel assembly 114). In this embodiment, an external force may be applied to move the nose 108 up and the tail 106 down to place the tail support 118 on the ground, but the aircraft 100 will return to the nose-down position upon removing the external force. For example, in some embodiments, an operator could apply throttle and up elevator to cause the propeller 110 to generate propeller wash over the elevators, to force the tail 106 down into support on the tail support 118. This provides greater flexibility in how the aircraft is operated. For example, an operator can taxi the aircraft with the elevator in a neutral position and the nose 108 down for visibility, then apply thrust and up elevator at the beginning of takeoff to position the aircraft in a tail-down attitude for takeoff.

In the hybrid configuration shown in FIG. 1, the center of gravity 122 is located just in front of the main wheel assembly 114 contact point. This, along with the provision of the nose wheel 120 and tail support 118, allows the pilot to operate the aircraft during landing as either a tricycle gear aircraft or as a conventional gear aircraft, as conditions warrant, and to operate the aircraft 100 as a tricycle gear aircraft and optionally as a conventional gear aircraft during takeoff.

For example, when approaching a paved runway, the pilot can land the aircraft 100 in the tricycle configuration by applying down elevator to push the nose 108 towards to the ground. When doing so, the placement of the main wheel assembly 114 close behind the center of gravity 122 allows the brakes to generate greater braking force than a conventional tricycle configuration (discussed below), due to the greater distribution of aircraft weight on the main wheel assembly 114. In this mode, the support provided by the nose wheel 120 makes the aircraft 100 less susceptible to nose-overs and ground loops.

In contrast, when approaching a field or other rough terrain, the pilot can land the aircraft 100 in the conventional “tail dragger” configuration with the tail support 118 on the ground, by applying up elevator to push the tail 106 towards the ground. In this mode, the nose wheel 120 is not used as a primary support during the initial landing, but the pilot may transition to the tricycle landing gear configuration (i.e., put the nose wheel 120 down by switching to down elevator) later in the landing process when there is less chance of the nose wheel 120 digging into the ground. During operation as a conventional landing gear aircraft, the nose wheel 120 is available to support the nose 108 of the aircraft 100 if the main wheel assembly 114 digs into the ground, to thereby reduce the likelihood of a nose-over. The nose wheel 120 can also contact the ground to help prevent a ground loop.

During takeoff, the aircraft 100 can be operated as a tricycle gear aircraft, with the nose down during initial taxiing and acceleration to the liftoff roll. In this configuration, the main wheel assembly 114 also optionally may be positioned to allow takeoff in the conventional configuration. For example, the aircraft 100 can start taxiing in the conventional configuration or transition from a tricycle configuration to the conventional configuration when the aircraft 100 gains enough speed to use the elevator to push the tail down.

Thus, an aircraft according to the embodiment of FIG. 1 is able to obtain the benefits of both conventional landing gear and tricycle landing gear, particularly during landing, at the pilot's discretion. The exact placement of the main wheels 114′ to obtain the benefits of this hybrid configuration will vary depending on the dimensions and characteristics of the aircraft 100.

Referring to FIG. 2, it is also envisioned that the main wheel assembly 114 may be movable to an optional second configuration, in which the aircraft 100 is in a typical tricycle landing gear configuration. In this configuration, the aircraft 100 is normally supported during takeoff and landing by the nose gear 120 in the front, and the main wheel assembly 114 in the rear. To this end, the positions of the main wheel assembly 114 and the center of gravity 122 are preferably selected such that the center of gravity 122 is between the nose wheel 120 and the main wheel assembly 114 when the aircraft 100 is on the ground with the nose wheel 120 in contact with the ground. More specifically, the nose wheel 120 defines a front point of contact 132 with the ground G, and the main wheel assembly 114 defines a rear point of contact 134 with the ground G, and the center or gravity 122 is located between the front point of contact 132 and the rear point of contact 134 with respect to a horizontal direction H extending from the front point of contact 132 to the rear point of contact 134.

In the second configuration, the main wheel assembly 114 and center of gravity 122 preferably are not configured to statically support the aircraft when the aircraft 100 is tilted back to rest on the tail support 118.

The option to move the main wheel assembly 114 between the hybrid and tricycle configurations enhances the flexibility of the aircraft 100, and offers manufacturers and consumers the ability to tailor a single aircraft for significantly different uses. For example, a pilot who primarily operates on paved landing strips may opt for the tricycle configuration during normal use to maximize ground stability and provide somewhat simpler landing procedures. But the same pilot might enjoy the option of transitioning the aircraft 100 to the hybrid mode to occasionally operate the aircraft 100 in fields. The option of being able to select one configuration or the other is also a benefit to manufacturers to reduce manufacturing costs and reach a larger range of potential customers. This option is also a benefit to aircraft owners, even if they never make a transition from one mode to another, to maximize the resale market of the aircraft. Other benefits also may be available.

The exact position of the center of gravity and contact points with the ground for both the first (hybrid) configuration and the second (tricycle) configuration will vary depending on the size, shape, and weight distribution of the particular aircraft. However, desirable positions for the main wheel assembly 114 in the first configuration and the second configuration can be determined using conventional methods. In one example, particularly a small single-engine aircraft such as a variant of the “Piper Cub” aircraft, the main wheel assembly 114 may be positioned in the second configuration such that the wheel axles are about 12 inches behind the center of gravity 122 (Dimension B in FIG. 2). When it is desired to move the main wheel assembly 114 to the first configuration, they are moved forward by a distance of about 9 inches to be about 3 inches behind the center of gravity 122 (Dimension A in FIG. 1).

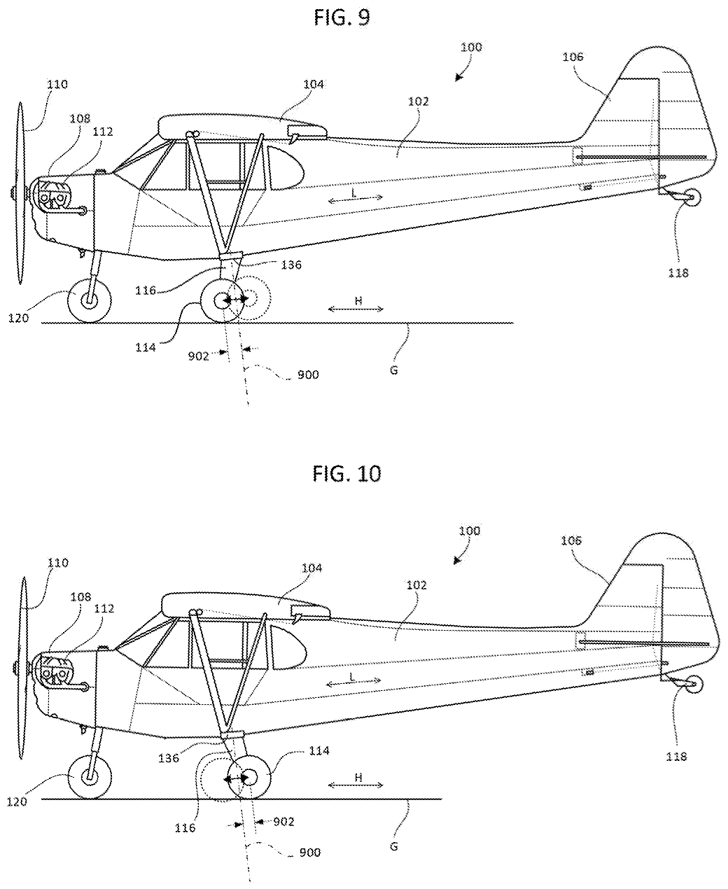

In this example, the main wheel assembly 114 is moved from one configuration to the other by sliding them along an axis that is parallel with the ground G when the aircraft 100 is supported on the nose wheel 120. This is not strictly required, and in other cases, the main wheel assembly 114 may be repositioned between the configurations by moving them along different directions (e.g., see FIGS. 9 and 10 in which the motion shown by the double-headed arrow is not parallel to the ground in either aircraft resting position), and through non-linear arcs of travel. Other alternatives and variations will be apparent to persons of ordinary skill in the art in view of the present disclosure.

FIGS. 3 through 6 show further details of an exemplary main landing gear assembly that can move between the two configurations shown in FIGS. 1 and 2. In this case, the main wheel assembly 114 has a cross-member 116 that is connected to a cross-member mount 136. The cross-member mount 136 is rigidly attached to the aircraft's frame 138 (only a portion of which is illustrated), and has two different mounting positions 140, 142. The first mounting position 140 is configured to hold the cross-member 116 with the main wheel assembly 114 in the first (hybrid) configuration, and the second mounting position 142 is configured to hold the cross-member 116 with the main wheel assembly 114 in the second (tricycle) configuration.

Each mounting position 140, 142 may include any suitable arrangement of connector locations to attach the cross-member 116 to the cross-member mount 136. For example, each mounting position 140, 142 may include a pair of holes 144 that are shaped and sized to receive corresponding threaded fasteners 146 (e.g., bolts and nuts). For convenience, the connector locations at the first mounting position 140 may be identical to the connector locations at the second mounting position 142 (i.e., have the same physical layout), but spaced apart in the longitudinal direction. Thus, a single set of fasteners may be used to mount the cross-member 116 in either position, without changing the layout of the connectors. However, this is not necessary in all embodiments, and it will be appreciated that the connector locations may vary depending on the layout of the remaining parts of the aircraft. For example, the fuselage or frame may narrow in the longitudinal direction L, leading to connector locations that are more closely spaced at whichever mounting position 140, 142 is located in the narrower region. The cross-member 116 also preferably includes its own connector locations to properly match the connector locations on the cross-member mount 136.

In the shown example, the cross-member mount 136 comprises two laterally-spaced mounting rails 148, which are connected to each other by lateral frame members 150 to form an assembly. The assembly is then rigidly attached to the aircraft frame 138, such that it is internal or external to the fuselage fairing. In the shown example, the assembly is internal to the fairing, such that the cross-member 116 moves along slots along either side of the fairing, which provides relatively low drag. Any suitable connections may be used for these attachments, such as nuts and bolts, welding, and so on. In the case of a retrofit of an existing aircraft, the cross-member mount 136 may be provided as a separate part that is attached to the frame 138. In the case of new construction (or a more substantial rebuild), the cross-member mount 136 may be integrally formed with the rest of the frame 138 (e.g., the rails 148 are formed as structural members of the frame 138).

The illustrated mounting rails 148 are formed as metal plates that extend in the longitudinal direction L and include the required holes 144 for connecting the cross-member 116 at the desired mounting positions 140, 142. Additional sets of holes 144 may be provided to connect the cross-member 116 at other positions that are between, forward, or aft of the first and second mounting positions 140, 142. Such additional positions may be useful, for example, to accommodate different weight distributions among different aircraft (particularly if the cross-member mount 136 is a retrofit part that may be used in multiple different aircraft), to accommodate different aircraft loadings that might arise from changes in loadout (e.g., adding auxiliary fuel tanks or other equipment), or according to prevailing use conditions (e.g., further forward for more extreme off-runway use, or further backwards for on-runway use with higher luggage weights). In some cases, an additional mounting position may be provided to position the main wheel assembly 114 at a typical position for a conventional landing gear, which would be well in front of the hybrid position, such as shown by the broken line depiction 154 of the main wheel assembly in FIG. 1. It is also envisioned that the connector locations may be omitted and added later according to user preferences.

The cross-member mount 136 also may have additional features to add operating convenience, safety or the like. For example, the cross-member mount 136 may include a cross-member track that holds the cross-member 116 adjacent the cross-member mount 136 as the cross-member 116 is moved between the mounting positions 140, 142. In the shown example, the cross-member track comprises a pair of lower rails 152 that extend parallel to and below the mounting rails 148. The lower rails 152 are connected at their ends to the mounting rails 148 to capture the cross-member 116 in place. Thus, the cross-member 116 is slidably mounted to the cross-member mount 136 by the lower rails 152, which allow the cross-member 116 to slide between the mounting positions 140, 142 when the fasteners are removed, but prevent it from falling away from the cross-member mount 136.

FIGS. 7 and 8 show an alternative embodiment of an aircraft 100 having a main landing gear assembly that is movable between a first (hybrid) configuration as shown in FIG. 7, and a second (tricycle) configuration as shown in FIG. 8. The two configurations function as described above in relation to FIGS. 1 and 2. In this example, the tail support 118 is a skid, rather than a wheel. Also in this example, the roles of the cross-member 116 and the cross-member mount 136 are reversed. Specifically, the cross-member 116 includes a first mounting position 700 and a second mounting position 702, which can be alternately and selectively attached to a common mounting point on the cross-member mount 136 to hold the main wheel assembly 114 in the first configuration and the second configuration, respectively.

Embodiments according to FIGS. 7 and 8 may have any suitable construction for the cross-member 116. For example, the cross-member 116 may be elongated in the longitudinal direction and have a first set of mounting holes located at the first mounting position 700, and a second set of mounting holes located at the second mounting position 702. The two sets of mounting holes are spaced in the longitudinal direction L (and may have identical configurations), to allow the user to selectively install the cross-member 116 to the cross-member mount 136 using one set of holes or the other to achieve the desired landing gear configuration. As with the embodiment of FIGS. 1 through 6, additional mounting holes may be provided or added to allow even more mounting positions. Other alternatives and variations will be apparent to persons of ordinary skill in the art in view of the present disclosure.

FIGS. 9 and 10 show another alternative embodiment of an aircraft 100 having a main landing gear assembly that is movable between a first (hybrid) configuration as shown in FIG. 9, and a second (tricycle) configuration as shown in FIG. 10. In this case, the cross-member 116 and cross-member mount 136 are reconfigurable by reversing the cross-member 116. Thus, to convert from one configuration to the other, the cross-member 116 is rotated about an approximately vertical axis 900 to reposition the main wheel assembly 114 in the forward position or the rearward position. In this case, the geometry of the cross-member 116 and the rotation axis 900 are selected to provide the desired offset between the two configurations. For example, the main wheel axles 902 may be located a distance 904 from the axis 900, that equals half of the total desired offset in the wheel positions between the two configurations.

The cross-member 116 may be configured to rotate relative to the cross-member mount 136 using any suitable collection of mechanisms or connectors. In one example, the cross-member 116 may be attached to the cross-member mount 136 by two bolts that are equally spaced from the lateral centerline of the aircraft 100, and so the configuration can be changed simply by removing the two bolts, reversing the cross-member 116, and reattaching the bolts. The cross-member 116 also may be attached to the cross-member mount 136 by a swivel that holds the two parts together as the cross-member 116 is being rotated. Such reconfiguration also may require reversing the brakes, or making other changes to address features that might not operate properly or as well when operated in reverse (e.g., reversing fairings on the wheels). Other alternatives and variations will be apparent to persons of ordinary skill in the art in view of the present disclosure.

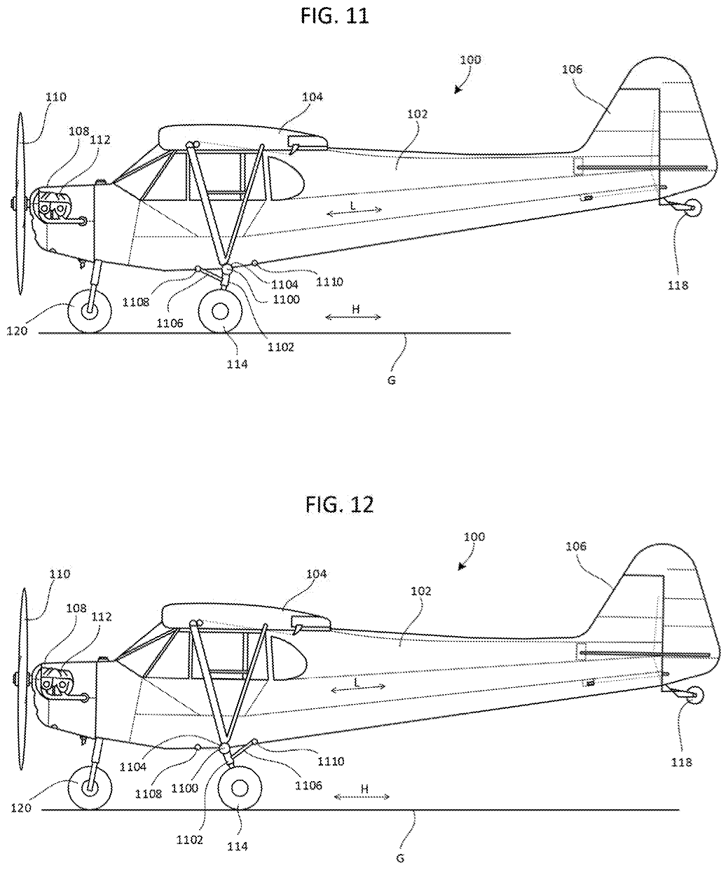

Another exemplary embodiment is illustrated in FIGS. 11 and 12. Here, the aircraft 100 has a main landing gear assembly that is movable between a first configuration (FIG. 11) and a second configuration (FIG. 12) by pivoting the wheel assembly 114 about a transverse axis 1100 extending in the left-right direction relative to the aircraft 100 (i.e., perpendicular to the page in the shown views). For example, each main wheel 114′ may be mounted on a separate strut 1102 that is connected the fuselage 102 by a pivot connector 1104 (e.g., a spherical rod end, ball and socket joint, cylindrical bearing or bushing, or the like). A stay 1106 is provided to attach the strut 1102 in either a forward position by connecting the stay 1106 to a forward mounting point 1108, or a rearward position by connecting the stay 1106 to a rearward mounting point 1110. The stay 1106 may have an adjustable length to tune the exact position of the wheel assemblies.

In an alternative embodiment, the pivot connector 1104 may comprise a connecting rod that rigidly joins the two wheel assembly 114. For example, each wheel 114′ may be rigidly connected by a splayed leg to one end of a horizontal shaft that acts as a cross-member, similar to what is shown in FIG. 5. The legs and wheels 114′, may be moved between the configurations by releasing the shaft from the fuselage, rotating the shaft about the transverse axis 1100 to place the wheels 114′ at the other position, and reattaching the fasteners to secure the shaft to the fuselage 102. The shaft also may be pivotally mounted to the fuselage 102, such as by having cylindrical portions that fit into corresponding cylindrical mounting blocks, to allow rotation of the entire assembly upon releasing rotation locks (e.g., stays 1106 or the like). Other alternatives and variations will be apparent to persons of ordinary skill in the art in view of the present disclosure.

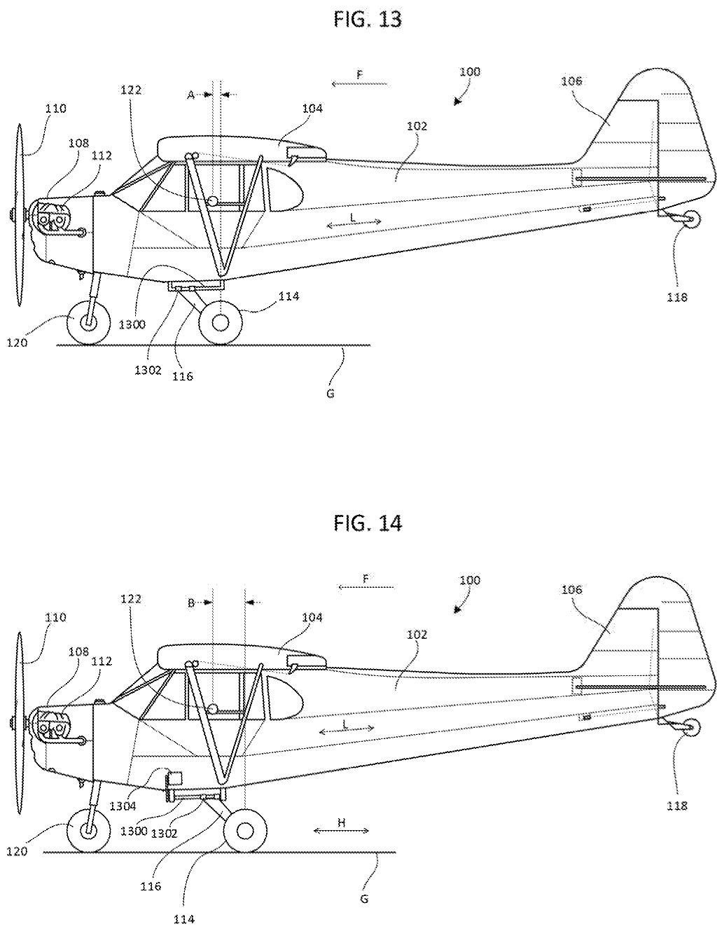

Another exemplary embodiment is illustrated in FIGS. 13 and 14. Here, the aircraft 100 has a main landing gear assembly that is movable between a first configuration (FIG. 13) and a second configuration (FIG. 14) by sliding the wheel assembly 114 along one or more rails 1300 (e.g., one central rail, or one rail 1300 on each lateral centerline of the aircraft 100). The wheel assembly 114 may be attached to the rails 1300 by any suitable connector that can slide between the two positions and be safely secured in either position. For example, the wheel assembly 114 may include collars 1302 that are secured in place by set screws or pins and further secured by safety wire. The rail or rails 1300 may be circular, T-shaped or have any other suitable shape. Stainless steel or other weather-resistant material may be used to improve service life of the exposed parts. It will also be appreciated that parts may be reversed, such that the rails 1300 are mounted on the wheel assembly 114 and the collars 1302 are mounted on the fuselage 102.

As another example (shown in FIG. 14), the rails 1300 may comprise threaded screws (e.g., acme thread screws or the like) and the collars 1302 may comprise internally-threaded mounting bosses. The screws may be manually rotated, or, as shown in FIG. 14, rotated by a motor 1304 via a gear or chain drive assembly to allow the pilot to move the main wheel assembly 114 from the cockpit during flight or when the aircraft 100 is on the ground. Other motorized or automated systems may be used on this or other embodiments. For example, electric motors or pneumatic or hydraulic actuators may be provided to permit in-flight or on-ground adjustment of the main wheel assembly. It will also be understood that manipulation of the wheel assembly while supporting the aircraft on the ground in this and many of the other embodiments described herein is possible because the nose wheel can roll back and forth as the main wheel assembly is moved relative to the fuselage.

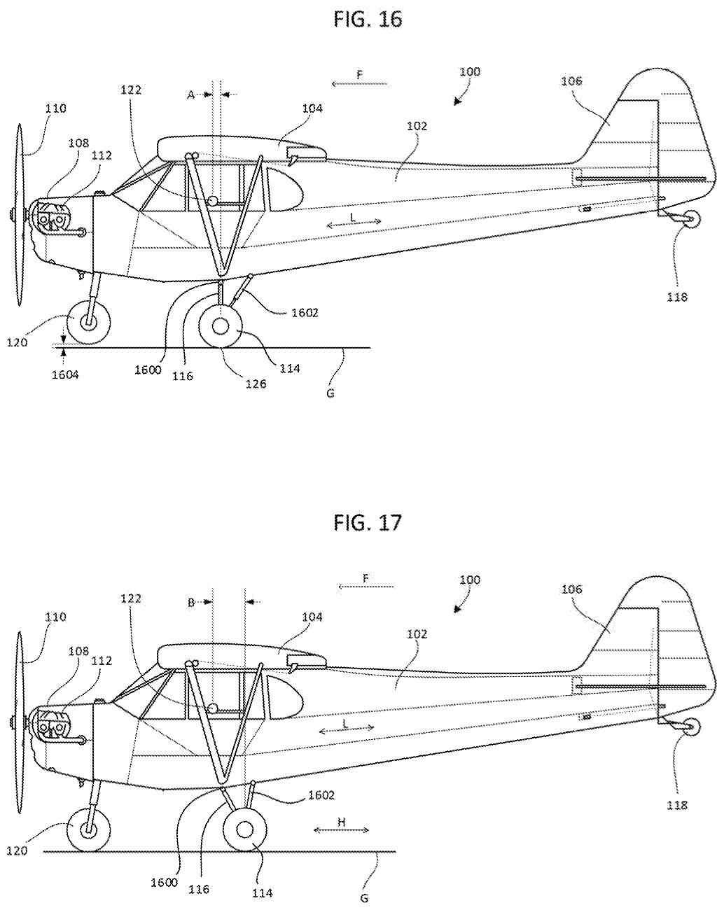

A similar exemplary embodiment is illustrated in FIGS. 16 and 17. Here, the aircraft 100 has a main landing gear assembly that is movable between a first configuration (FIG. 16) and a second configuration (FIG. 17) by rotating the wheel assembly 114 relative to the fuselage 102, such as described in relation to the embodiment of FIGS. 11 and 12. As with the previous embodiment, each wheel may be separately attached to pivot relative to the fuselage 102, or both wheels may be mounted on a common cross-member 116 such that they always move together. The wheel assembly 114 may be pivotally attached using any suitable connector, such as a hinge pivot 1600 or a spherical rod end.

The position and movement of the wheel assembly 114 is controlled by one or more extendable struts 1602, which may be located in front of or behind the wheel assembly pivot 1600. The extendable struts 1602 may comprise any suitable extendable mechanism, such as screw jacks or pneumatic or hydraulic piston and cylinder assemblies. The extendable struts 1602 are operatively connected between the fuselage 102 and the wheel assembly 114, such as by being connected to both by spherical rod ends, ball joints, or pivot connectors. The extendable struts 1602 may be operated while the aircraft 100 is on the ground or supported on jacks, and optionally may be operable while the aircraft 100 is in the air. One or more motors or sources of pressurized fluid or gas may be provided to operate the extendable struts 1602. The extendable struts also may be manually-operated (e.g., a manually cranked screw jack).

The geometry of the wheel assembly 114 and extendable struts 1602 may be selected to provide additional benefits, in addition to moving the wheel assembly 114 relative to the aircraft's center of gravity 122. For example, as shown in FIG. 16, the contact point 126 between the wheel assembly 114 and the ground G may be positioned at different vertical elevations in the two different positions, such that the angle of attack of the aircraft differs in the two different configurations. In the shown example, the contact point 126 is lower when the wheel assembly 114 is in the first configuration (FIG. 16), such that the nose wheel 120 must descend by an additional distance 1604 to contact the ground G. Thus, when the nose wheel 120 has dropped this distance 1604, the aircraft wings are tilted down at a negative angle of attack, which can help increase stability in windy conditions. It is also envisioned that the wheel assembly cross-member 116 (or separate wheel mounting struts) may have adjustable lengths to provide even greater flexibility in reconfiguring the wheel assembly 114. For example, the cross-member may be adjusted to move the wheel assembly 114 closer to or further from the fuselage 102 to tune the angle of attack in either configuration. Other alternatives and variations will be apparent to persons of ordinary skill in the art in view of the present disclosure.

It will be appreciated that in each of the foregoing embodiments, one or both of the cross-member 116 and the cross-member mount 136 is configured to selectively and alternately fix the cross-member 116 to the fuselage in a first configuration with the main wheel assembly 114 in a first longitudinal position, and in a second configuration with the main wheel assembly 114 in the second longitudinal position. It is also envisioned that both the cross-member 116 and the cross-member mount 136 may be configured to allow such reconfiguration (e.g., a combination of the embodiments to allow multiple repositioning options).

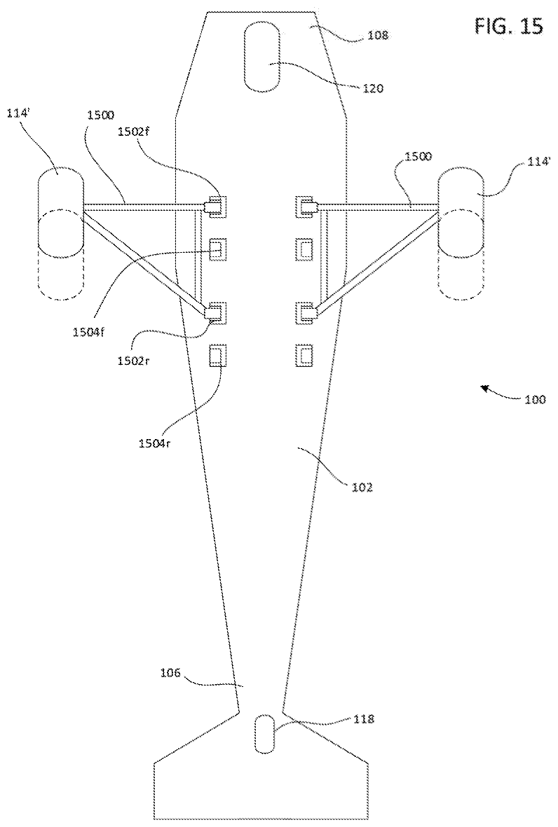

Other alternatives and variations will be apparent to persons of ordinary skill in the art in view of the present disclosure. For example, in some embodiments the main wheel assembly 114 may be movable between the hybrid and tricycle positions (or to other positions) by separately moving each main wheel 114′. An example of this is shown in FIG. 15, which shows a schematic bottom view of an aircraft 100 having main wheels 114′, a nose wheel 120 and a tail wheel 118. In this case, each main wheel 114′ is separately attached to the fuselage 102 by its own strut 1500. The fuselage 102 includes multiple strut mounting locations. In this example, the struts 1500 can be attached to the fuselage 102 at two locations. Specifically, each side of the fuselage 102 includes a first pair of clevis mounts 1502f, 150r to which a strut 1500 is attached to place the associated main wheel 114′ in the hybrid configuration, and a rear pair of clevis mounts 1504f, 1504r to which the strut 1500 is attached to place the associated main wheel 114′ in the tricycle configuration. Each clevis mount may include a conventional double-shear pinned connection. Other types of attachment may be used in other embodiments.

It will also be appreciated that the landing gear need not be directly attached to the fuselage of the aircraft. For example, the main landing gear may be indirectly attached to the fuselage by being mounted on the wings, as is often the case with low- and mid-wing aircraft (i.e., aircraft in which the wing is located at the vertical midline of the fuselage or below). It will be understood that all references herein to connecting the landing gear assemblies to the fuselage include direct or indirect attachment.

It will be appreciated from the foregoing disclosure that embodiments of the invention may provide various benefits and advantages over conventional aircraft and landing gear. In addition to the benefits provided by the hybrid configuration (such as discussed above), adding a movable landing gear assembly provides even greater flexibility to the operator. For example, the operator may selectively change the landing gear configuration depending on the expected use conditions of the aircraft, such as: selecting the hybrid landing gear configuration for off-runway use; selecting the tricycle landing gear configuration for on-runway use; selecting the tricycle landing gear configuration when heavy crosswinds are expected or to obtain negative wing angle of attack to improve stability in windy weather; or selecting the hybrid landing gear configuration for short takeoff and landing operations. Embodiments may also may provide additional stability and safety when operating in either configuration, by including a nose gear when operating in the hybrid landing gear configuration with the tail down (thus helping prevent nose over), and including a tail gear when operating in the tricycle landing gear configuration (thus helping prevent damage from ground strikes). The foregoing benefits and advantages are provided as examples only, and it will be understood that embodiments may or may not accomplish or provide any particular one or the enumerated benefits.

The present disclosure describes a number of inventive features and/or combinations of features that may be used alone or in combination with each other or in combination with other technologies. The embodiments described herein are all exemplary, and are not intended to limit the scope of the claims. It will also be appreciated that the inventions described herein can be modified and adapted in various ways, and all such modifications and adaptations are intended to be included in the scope of this disclosure and the appended claims.

1. An aircraft comprising:
a fuselage extending in a longitudinal direction from a nose to a tail;
a main wheel assembly comprising a first main wheel spaced in a transverse direction from a second main wheel, the transverse direction being perpendicular to the longitudinal direction;
one or more pivots connecting the main wheel assembly to the fuselage, the one or more pivots having a rotation axis extending in the transverse direction such that the main wheel assembly is pivotable relative to the fuselage between a first fixed position with the first main wheel and the second main wheel in a first longitudinal position behind a center of gravity of the aircraft, and a second fixed position with the first main wheel and the second main wheel in a second longitudinal position behind the center of gravity of the aircraft; and
one or more extendable struts operatively connected between the main wheel assembly and fuselage, and operable to move the main wheel assembly between the first fixed position and the second fixed position.

2. The aircraft of claim 1, further comprising a nose wheel located adjacent the nose and a tail support located adjacent the tail, with the main wheel assembly between the nose wheel and the tail support with respect to the longitudinal direction.

3. The aircraft of claim 2, wherein the tail support comprises a wheel or a skid.

4. The aircraft of claim 2, wherein at least one of the nose wheel and the tail support is removable.

5. The aircraft of claim 1, wherein the first main wheel and the second main wheel are separately movable between the first longitudinal position and the second longitudinal position.

6. The aircraft of claim 1, wherein the one or more extendable struts comprise one or more screw jacks.

7. The aircraft of claim 1, wherein the one or more extendable struts comprise one or more hydraulic piston and cylinder assemblies.

8. The aircraft of claim 1, wherein the one or more extendable struts comprise one or more pneumatic piston and cylinder assemblies.
